(19) United States
(12) Patent Application Publication
(10) Pub. No.: US 2009/0090817 A1
(43) Pub. Date: Apr. 9, 2009

(54) Aircraft configuration, gas turbine engine, controller and trim system for neutralizing pitching moments with power changes

(76) Inventor: Gary H. Monka, Marlboro, NJ (US)

Correspondence Address: CANAVAN & MONKA LLC, 62 GROVE STREET, SOMERVILLE, NJ, 08876, US

(21) Appl. No.: 12/002,106

(22) Filed: Dec. 14, 2007

Related U.S. Application Data
(60) Provisional application No. 60/998,171, filed on Oct. 9, 2007.

(51) Int. Cl. B64C 13/16

(52) U.S. Cl. 244/76 R; 60/771

(57) ABSTRACT

An aircraft, gas turbine engine, controller and trim system for neutralizing pitching moments caused by power changes and consequent changes in engine thrust. Several expedients are disclosed, utilizing either thrust vectoring or automatic aircraft trim augmentation in response to thrust variations, made either by throttle setting changes caused by a pilot or a flight management control (FMC)/autopilot system.

### CROSS REFERENCE TO RELATED APPLICATIONS

This nonprovisional application claims the benefit of U.S. Provisional Appl. Ser. No. 60/998,171, filed Oct. 9, 2007 and entitled AIRCRAFT AND GAS TURBINE ENGINE CONFIGURATION AND ASSEMBLY WITH THRUST VECTORING TO MINIMIZE PITCHING MOMENTS WITH POWER CHANGES.

### FIELD OF THE INVENTION

The present invention generally relates to improvements in the field of aviation, and more particularly, to a novel configuration for a gas turbine powered aircraft that neutralizes pitch excursions with power changes, confers superior foreign object damage (FOD) protection, and improves aircraft utility.

### BACKGROUND

The advent of modem low-cost turbofan engines, full authority digital engine controls (FADEC), and advanced avionics, is making affordable single-engine jet aircraft a potential reality for many aircraft owners and small businesses. Many of these individuals/companies currently don't have either the need or financial wherewithal to purchase and maintain a traditional business jet.

In addition, modem gas turbine engines have become so reliable that the time of the “single-engine” passenger jet aircraft has come. Since the 1980s, modem twin-engine jets have been approved for “Extended-Range Twin Engine Operational Performance Standards” (ETOPS). While single engine turboprops such as the Socata TBM-700/850, Pilatus PC-12 and Cessna Caravan have been available for many years, single-engine jet aircraft are now on the verge of making the dream of flying a pure jet aircraft a reality for the typical general aviation (GA) pilot/business owner. Many of these individual and/or companies would like to avoid the hassles of airline travel but may not realistically be able to afford (or justify) the acquisition and operational costs associated with a complex twin-jet, not to mention the onerous training requirements that are set by the aircraft insurance industry.

The last several years have seen the adoption of ballistic recovery parachutes, such as those made by BRS systems, in production single engine aircraft. The BRS is now standard equipment in the Cirrus Design Corp. (“Cirrus”) SRXX series of aircraft, is planned for several other new designs, and is available as an aftermarket option on several existing models. This device has made flying behind a single engine a lot more palatable to many pilots and especially their passengers. Cirrus has enjoyed enormous success with its single engine line of piston aircraft, and many attribute at least a portion of that success to the BRS.

With advances in avionics and engine technology that are now keeping pace with the personal computing industry, it's no surprise that a myriad of very light jet (VLJ) offerings have suddenly appeared on the horizon. While the true market potential for these (still relatively expensive) aircraft remains to be seen, the reality is that such aircraft may be a viable replacement for the typical “large” (by single engine piston standards) business jet that is currently flown by many owner/operators on most missions. The typical mid-sized business jet, such as a Lear (Bombardier), Citation or Hawker flies stage lengths of only a few hundred miles, often with only 1 or 2 passengers. Such aircraft are typically flown by a professional crew under Federal Air Regulation (FAR) Part 135, and are relatively expensive to purchase/operate, even for the most well-heeled individuals and corporations.

The Eclipse Aviation (“Eclipse”) EA-500 twin-jet, is the first of the modem VLJs. At present, a plurality of single and multi-engine VLJs are under development, with some of these slated to enter service by 2010.

Proper placement of the engine is one problem that confronts the designers and engineers of any single engine turbofan-powered aircraft. With the goal to maximize internal space for carrying passengers and cargo, mounting the engine within the fuselage, as in a typical military jet aircraft, is not a good option. The design considerations of a modem transport are completely different from those optimized for military uses.

The Diamond D-Jet, currently under development by Diamond Aircraft Corporation, incorporates a single jet engine that is disposed within the fuselage beneath the passenger compartment/pressure vessel. However, one issue with this design is the potential for ingesting foreign objects and/or debris (FOD) arises due to the low placement of the air intakes, which can easily trash the engine. This configuration typically necessitates complex ducting and tortuous flowpaths to ensure that the engine intake to the compressor is protected. Unfortunately, such ducting is inefficient and can rob the engine of efficiency if not properly designed.

Another new design by the Epic Aircraft Co. (“Epic”), is the “Victory” Jet, unveiled to the public during the summer of 2007. This aircraft has a “scoop-like” air intake that projects above the fuselage and communicates intake air to an engine wholly disposed therein, similar to the venerable Boeing Aircraft Co. (“Boeing”) 727 series, which was first introduced into passenger service in the early 1960s.

Other proposals under development, include Cirrus' yet unnamed offering simply known as “the-Jet.” The anticipated first flight of the Cirrus Jet is still undisclosed and no prototype is known to exist as of the filing date of this application. Another similar proposal from Eclipse is the Eclipse Concept Jet (ECJ), which made a surprise debut as a non-conforming prototype at the annual Oshkosh airshow (Airventure 2007) in late July, 2007.

The Cirrus Jet and ECJ are true VLJs, which are squarely aimed at the typical owner/pilot, who may have little or no high performance or turbine experience. Both of these aircraft have a V-tail configuration and a single turbofan engine mounted on top of the aircraft such that the engine exhaust flows between the stabilizers of the V-tail. The Cirrus Jet currently exists only in the form of a mock-up, and very few details and performance figures (with the exception of a targeted cruise speed somewhere around 300KTAS and a 25,000' operational ceiling limitation) have been made publicly available.

Another single engine VLJ, which is currently under development, is the Piper™ Jet, also slated to enter service around 2010. This expedient utilizes a single turbofan that is mounted on a pylon above the fuselage and coincident with the horizontal stabilizer, akin to the McDonnell Douglas DC-10 tri-jet.

The above the fuselage single jet engine concept was first introduced by Germany during WWII in the form of the Heinkel He-162. This revolutionary (for its time) aircraft had a single jet engine mounted above the fuselage.

A “top-mounted” jet engine has advantages for a passenger carrying aircraft, since internal space for passengers and fuel can be maximized. Unfortunately, several drawbacks are inherent in such a design. Since the thrust line is disposed above the longitudinal axis of the aircraft, each throttle adjustment and consequent change in engine thrust change will tend to pitch the aircraft either up or down. This characteristic is undesirable in any aircraft, and can be downright dangerous if power is suddenly reduced and the aircraft pitches up faster than the aerodynamic trim system can compensate therefor, or if an out of sync and/or un-damped pitch oscillation develops.

In view of the shortcomings associated with above-the-fuselage engine designs, the present invention provides several expedients directed to providing a single-engine turbofan powered passenger carrying aircraft with predictable and desirable handling characteristics.

### SUMMARY OF THE INVENTION

A novel aircraft and gas turbine engine assembly for a jet aircraft is shown and described herein. In accordance with one aspect of the invention, an aircraft includes a V-tail comprising a pair of stabilizers (either stabilators or incorporating ruddervators), for effectuating pitch and yaw control. The aircraft advantageously comprises a gas turbine engine mounted above the fuselage, where the exhaust nozzle of the engine is positioned relative to the fuselage and stabilizers such that engine exhaust passes unimpeded between the stabilizers. Preferably, the engine is disposed relative to the V-tail so as to minimize deleterious effects of hot engine exhaust emitted from the exhaust nozzle. The air inlet of the engine may be disposed relative to the longitudinal axis and V-tail forward of the leading edges in any suitable location that provides for an optimum center-of-gravity (cg) range for the aircraft.

In one preferred expedient, a trim system for the aircraft comprises a thrust vectoring assembly constructed and arranged for changing a flow path of engine exhaust relative to a longitudinal axis of the aircraft to neutralize pitching moments resulting from changes in throttle settings and consequent variations in engine thrust. In a preferred embodiment of the invention, the thrust vectoring assembly is coupled to a controller, such as a FADEC system or other module (i.e., Flight Management Computer (FMC)/Autopilot (AP)) associated with a throttle control system of the aircraft. Alternatively, the thrust vectoring assembly is mechanically, electrically or electromechanically, optically or electro-optically linked (i.e., “fly-by-wire”) to either a throttle assembly that is manually controlled by the pilot, or a combination of a FMC/FADEC and/or manual linkage as described further hereinbelow.

In accordance with another aspect of the invention, a controller, such as part of a FADEC or FMC/AP is disclosed for sending control signals to an aircraft trim system to modify trim settings for the aircraft in response to power setting changes and consequent variations in engine thrust, so as to minimize undesirable pitching moments.

Another aspect of the invention discloses a gas turbine engine including a controller as described in the foregoing.

Yet another aspect of the invention discloses a controller including a memory medium containing machine readable instructions which, when executed by a processor, enable the controller to generate control signals to proportionally adjust a movement of the trim system to maintain the aircraft in a trimmed state irrespective of the throttle setting.

Another aspect of the invention provides a trim system that mechanically, electrically or electromechanically adjusts the trim of the horizontal stabilizer and/or ruddervators (in a V-tail) to compensate for changes in engine thrust of an above-the-fuselage mounted jet engine. The trim system is operably coupled to the controller described above.

Other aspects of the invention include methods for maintaining an aircraft having an engine mounted above a fuselage thereof, in a trimmed state by processing signals representing throttle settings; responsive to responsive to said throttle settings, calculating a thrust vectoring offset relative to a longitudinal axis extending through the aircraft; and directing engine thrust along a path relative to the longitudinal axis in accordance with the calculated thrust vectoring offset so as to neutralize pitching moments caused by variations in engine thrust.

Many additional advantages of the present invention will become apparent hereinafter, as the present invention is described in detail with particular reference to the accompanying drawings.

### BRIEF DESCRIPTION OF THE DRAWINGS

FIG. 1 is a perspective view of a single engine turbofan powered aircraft in accordance with an aspect of the invention;

FIG. 2 is a schematic of a thrust vectoring system in accordance with an aspect of the invention; and

FIG. 3 is a schematic depicting details of an exemplary embodiment of a thrust vectoring assembly;

FIG. 4 is a schematic of a top-mounted turbofan coincident with the horizontal stabilizer of the aircraft;

FIG. 5 is a flow diagram of methodology in accordance with an aspect of the invention for neutralizing pitching moments with power changes for an aircraft by directing engine thrust relative to a longitudinal axis of the aircraft in response to such power changes.

### DETAILED DESCRIPTION OF THE PREFERRED EMBODIMENTS

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

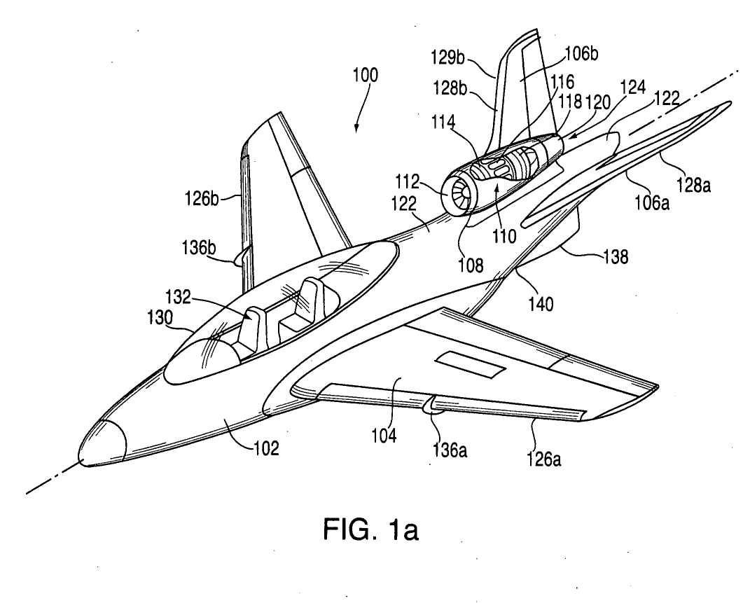

FIGS. 1a, 1b and 1c are perspective, left side elevation and frontal views, respectively, of an illustrative single engine turbine powered aircraft 100 comprising a fuselage 102, wings 104a, 104b and a V-tail, comprising stabilizers 106a, 106b extending substantially 45° angles from a vertical axis A-A bisecting the fuselage 102, all of which components are well known in the art. The exemplary embodiment thereof is in the form of a 2-seat “sport jet,” however, this configuration is generic and any V-tail configuration can be used to practice aspects of the invention. A longitudinal axis B-B extends through a center of mass/cg of the fuselage as shown in the drawings.

In accordance with a first aspect of the invention, a gas turbine engine 110 (preferably a turbofan, although a turbojet or any hereinafter developed gas turbine technology may be employed) is mounted above the fuselage 102 and disposed generally forwardly of the V-tail stabilators 106a, 106b at an axial location relative to a fixed datum (not shown) to accommodate a desired center of gravity (cg) range in accordance with design specifications for the aircraft 100. In the exemplary embodiment, as shown in FIG. 1a the engine 110 is mounted on a pylon 108 and generally includes an air inlet 112, compressor section 114, combustion assembly 116, turbine section 118 and exhaust nozzle 120 (all of which are well known). The exhaust nozzle 120 is positioned relative to the fuselage 102 and V-tail such that engine exhaust passes generally unimpeded between the stabilizers 106a, 106b thereof. Preferably, the engine 110 and specifically, the exhaust nozzle 120/distal end 124 of the engine is disposed relative to the V-tail stabilators 106a, 106b so as to minimize any deleterious effects of hot exhaust gas that is emitted from the exhaust nozzle 120 on either of stabilizers 106a, 106b, and/or an upper portion 122 of the fuselage.

The illustrative aircraft 100 includes features that are well known in the art such as deicing provisions 126a, 126b (TKS (fluid) by Aerospace Systems and Technologies Inc., ThermaWing™ (heated wing) by Kelly Aerospace, boots, bleed air and the like) on the leading edges of the wings, and similar equipment 128a, 128b on the stabilizers 106a, 106b. The aircraft 100 includes a canopy 130 and seating 132 in a pressurized cockpit. The wings 104a, 104b include an undercarriage assembly 134a, 134b and a nose gear assembly 136 that extends beneath the cockpit area in a conventional tri-gear configuration. The wings may include stall fences 136a, 136b, to control span wise flow and to ensure or minimize the introduction of turbulent flow into the air intake 112 of engine 110 at high angles of attack, or any other known or hereinafter developed device or system (i.e., split wing airfoil as used, for example, on the Cirrus SR-2X or Columbia 350/400, vortex generators, vortilons, and/or the like) to tame stall/slow flight characteristics if required. Additionally, strakes 138 may be provided on a lower section 140 of fuselage 102 to control flow around the tail at high angles of attack.

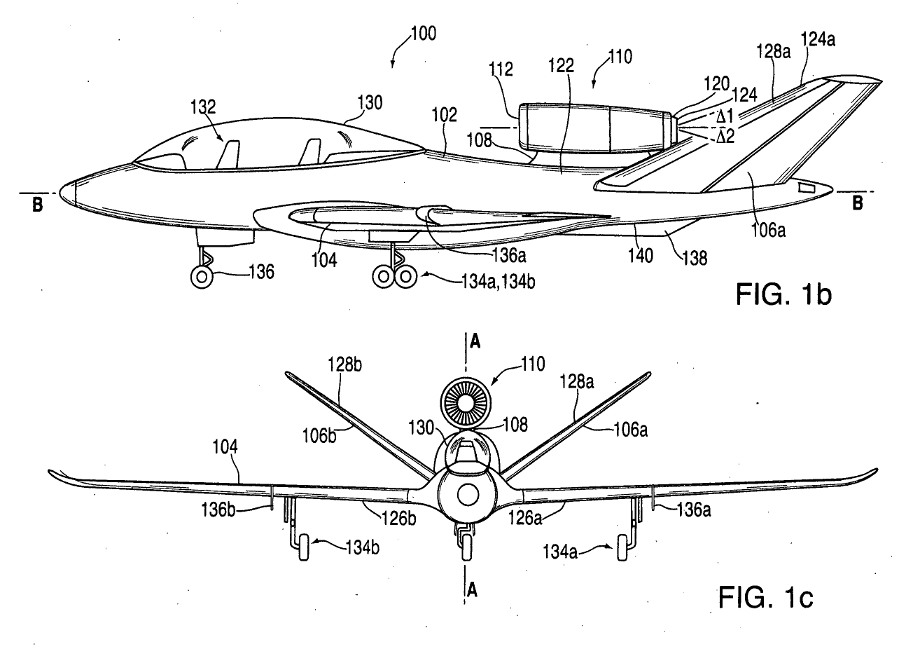

Referring now to FIG. 2, in accordance with another aspect of the invention, a trim system for neutralizing pitching moments from throttle changes comprises a thrust vectoring assembly 200 coupled to a controller (or engine throttle control system/FADEC) 210, hereinafter generally referred to as a “controller.” The thrust vectoring assembly 200 is constructed and arranged to controllably vector engine exhaust (characterized generally at 204) relative to the longitudinal axis B-B extending parallel to that of the longitudinal axis that passes through the center of mass of the aircraft (upwardly at angle Δ₁ and downwardly at angle Δ₂), so as to at least “substantially” (but preferably completely) neutralize any pitching moments attributable to power changes made either by the pilot directly or via a FMC/autopilot (AP) system 214 Preferably, the thrust vectoring assembly 200 is electrically, optically or electro-optically coupled at 208 to the engine controller 210, which in turn couples to a throttle assembly or control 212 that receives throttle inputs either manually from the pilot or via the FMC/AP 214. It will be appreciated by those skilled in the art, that the throttle assembly/control 212 as described herein may comprise a mechanical and/or electrical apparatus that is controlled directly by the pilot, or alternatively, a module or component that is part of the FMC 214 or autopilot assembly. The FMC/AP 214 may communicate with an independent air-data computer and/or attitude heading reference system 216 of the type known in the art, or alternatively this functionality may be provided in the FMC/AP module 214. Furthermore, the FMC/AP communicates with the flight control surfaces/aero trim 218 in a conventional manner (i.e., mechanical or fly-by-wire). The exact configuration of the throttle assembly 212, FMC/AP 214, ADHRS 216, flight controls 218 and controller 210 is not relevant here, as a variety of permutations may be employed within the scope of the invention. Irrespective of the configuration of the flight control system, an aspect of the invention(s) disclosed herein provides trim control for the aircraft automatically in response to changes in engine thrust, whether such changes result from manual input by the pilot or via a FMC/AP, and in a first illustrative embodiment, by changing the angle of the engine thrust relative to the longitudinal axis of the aircraft upon calculating the required “thrust vectoring offset” required to neutralize the pitching moment when thrust is either increased or decreased.

In the exemplary embodiment, the controller 210 is adapted for sending control signals to a mechanism associated with the thrust vectoring assembly 200. As will be appreciated by those skilled in the art, the controller 210 may be any type of general purpose or special computer including, inter alia, a processor 220 and computer memory comprising a machine readable memory medium 222 containing executable programmable instructions, either embodied in hardware, software, firmware or the like, which when executed by the processor, enable the controller 214 to generate control signals, which when communicated to the thrust vectoring assembly 200, enable the same to proportionally adjust the thrust line either upwardly or downwardly as described above to maintain the aircraft in a neutrally state without the need for either the pilot or the FMC/AP to aerodynamically re-trim the aircraft. In accordance with an aspect of this invention, a methodology for neutralizing pitching moments due to throttle changes comprises the steps of: processing signals representing such throttle settings; then, responsive to the new throttle settings, calculating a thrust vectoring offset Δ₁ (upwardly—nose down pitch), or Δ₂ (downwardly—nose up pitch) relative to the longitudinal axis B-B of the aircraft; and directing engine thrust 204 along a path relative to the longitudinal axis of the aircraft in accordance with the calculated thrust vectoring offset (either Δ₁ or Δ₂) so as to neutralize the pitching moments caused by power setting changes and consequent variations in engine thrust. The processor utilizes power setting inputs that correspond to known thrust values and calculates the vectoring offset by taking into account variables including, but not limited to, aircraft speed, weight, trim condition, ambient temperature, pressure, instantaneous and transient pitch settings, trim settings and the like, as will be appreciated by those skilled in the art. As described above, the controller 210 may either be incorporated into the FADEC system for the engine, a separate component/module, or even incorporated into the FMC/AP assembly. The controller/FMC/AP components may be part of the engine assembly, reside external thereto within the fuselage of the aircraft, or even in a dedicated fairing or other structure associated with the aircraft. It will be further appreciated that these components may be split into individual modules or other components.

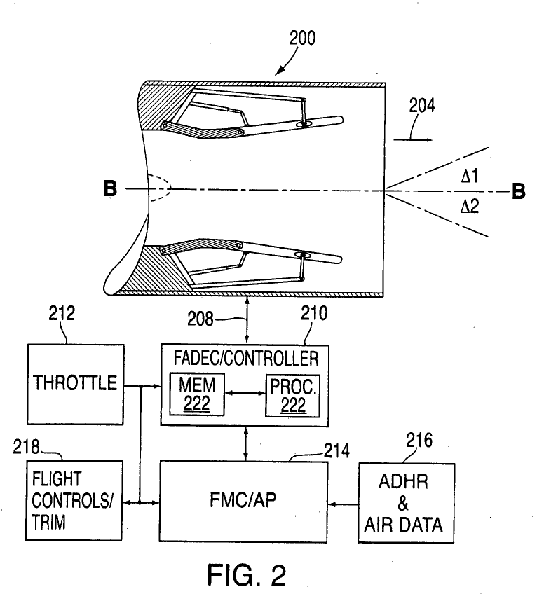

FIG. 3 depicts a detailed schematic of a thrust vectoring assembly 300 which comprises, in an exemplary embodiment, a pair of thrust vectoring plates 302a, 302b that are mounted relative to a longitudinal axis 304 extending through an axial-flow turbofan engine 306 (partial view thereof shown). The thrust vectoring plates 302a, 302b are disposed within, or otherwise located proximal to a nozzle assembly 320 of the engine. The thrust vectoring plates 302a, 302b move in unison or independently relative to the longitudinal axis 304 to direct the engine thrust either upwardly or downwardly relative to the longitudinal axis 304 of the engine 306, and the longitudinal axis of the aircraft, the latter being the relevant orientation here. It will be appreciated by those skilled in the art that many variations thereof can be employed. Examples of prior art structures that accomplish this functionality are U.S. Pat. No. 5,687,907 to Holden, which is assigned to United Technologies Corp., and U.S. Pat. No. 4,993,638 to Lardellier, which is assigned to Societe Nationale d'Etude et de Construction de Mateurs d'Aviation (“SNECMA”), the disclosures of which are incorporated herein by reference.

In this manner, pitch changes caused by power changes due to the placement of the engine 306 above the fuselage and thus away from the longitudinal axis of the aircraft can be minimized by moving the thrust vector appropriately in coordination with the application or removal of power by the pilot/FMC/AP. In this regard, as power is increased, the additional engine thrust resulting from the new power setting tends to pitch the nose of the aircraft downwardly due to the pitching moment attributable to displacing the engine from the centerline/longitudinal axis of the aircraft. Conversely, the removal of power has the opposite effect, which tends to create a nose-up pitching moment. Since such effects are undesirable, the inclusion of the thrust vectoring system in accordance with an aspect of the present invention provides for a smoother flight regime and eliminates the need for the pilot to re-trim the aircraft or add/remove control pressure with each power change.

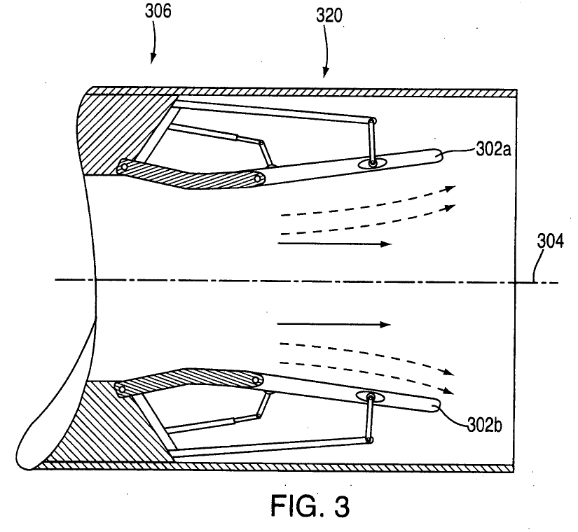

Referring now to FIG. 4, there is shown yet another embodiment of an aircraft 400 utilizing a top-mounted jet engine 410 disposed on a pylon 408 above an upper portion 422 of a fuselage 402, substantially in alignment with a vertical stabilizer 404. This expedient employs traditional horizontal stabilizers 406a, 406b. The operating principles of the thrust vectoring system are the same as that described above with respect to the V-tail embodiment.

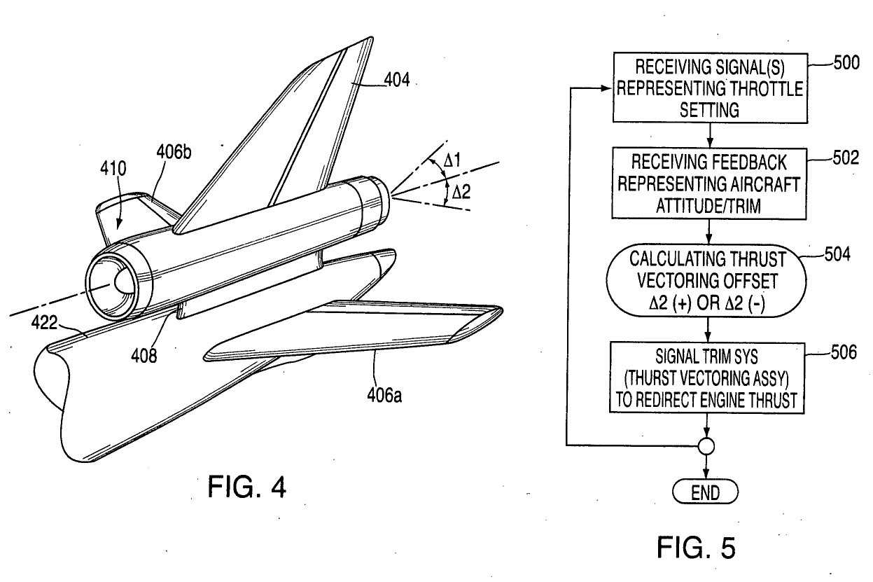

FIG. 5 is a flow diagram of an exemplary methodology for re-trimming an aircraft having jet engine mounted at a vertical offset relative to a longitudinal axis passing through a center of mass/cg of the aircraft. In this regard, the method comprises a first step 500 of receiving a signal(s) representing a throttle setting and/or a second step 502 of receiving feedback from the flight controls of the aircraft and/or input from an air-data computer. In step 504, the controller calculates the required thrust vectoring offset Δ₁ (upwardly—nose down pitch), or Δ₂ (downwardly—nose up pitch) required to substantially or, optimally if possible, completely neutralize any pitching moments attributable to the changes in engine thrust resulting from throttle setting changes either selected manually by the pilot or via a FMC/AP. In step 506, the controller signals the aircraft trim system, which may either be a thrust vectoring assembly as shown and described in the foregoing, or alternatively, a mechanical trim system that aerodynamically trims the aircraft via the flight control surfaces in accordance with well-known techniques using at least one of adjustable stabilizers, spring cartridges, and trim tabs. In a more general sense, pitching moments on the aircraft may be sensed utilizing a variety of sensors, including but not limited to data provided by the FMC/ADHRS or the like, with the controller then automatically calculating the required thrust vectoring offset to counteract such pitching moments. In all events, the process automatically compensates for any and all changes in engine thrust that tend to induce such undesirable pitching moments in a manner that is completely transparent to the pilot, thus providing for enhanced safety of flight and more pleasurable handling characteristics for the aircraft.

The present invention has been shown and described in what are considered to be the most practical and preferred embodiments. It is anticipated, however, that departures may be made therefrom and that obvious modifications will be implemented by those of ordinary skill in the art.

I claim:

1. A gas turbine engine for an aircraft, comprising:
a controller adapted to process signals representing at least one of power settings for the gas turbine engine and feedback representing pitching moments responsive to changes in said power settings and consequent variations in engine thrust, and to output control signals to re-trim the aircraft.

2. The gas turbine engine recited in claim 1, wherein the engine is disposed in a cowling constructed and arranged to be mounted above a fuselage of the aircraft.

3. The gas turbine engine recited in claim 2, wherein the engine cowling is constructed and arranged to be disposed substantially between a V-tail comprising a pair of stabilizers for pitch and yaw control, such that engine exhaust passes between the stabilizers.

4. The gas turbine engine recited in claim 2, wherein the controller is adapted to output commands for the trim system to neutralize trim changes in response to said variations in engine thrust.

5. The gas turbine engine recited in claim 4, wherein the controller is adapted to communicate with the trim system over a network interface.

6. The gas turbine engine recited in claim 4, wherein the controller is adapted to communicate with the trim system over an optical interface.

7. The gas turbine engine recited in claim 4, wherein the controller is adapted to communicate with the trim system over an electrical interface.

8. The gas turbine engine recited in claim 4, wherein the trim system comprises a thrust vectoring assembly for changing a flow path of engine exhaust relative to a longitudinal axis of the aircraft.

9. A controller adapted to output control signals to re-trim an aircraft having a gas turbine engine mounted on top of a fuselage of the aircraft in response to changes in power settings and consequent variations in engine thrust.

10. The controller recited in claim 9, wherein the controller is adapted to receive input signals representing throttle settings.

11. The controller recited in claim 10, wherein the controller is adapted to communicate with the trim system over a network interface.

12. The controller recited in claim 11, wherein the controller is adapted to communicate with the trim system over an optical interface.

13. The controller recited in claim 12, wherein the controller is adapted to communicate with the trim system over an electrical interface.

14. An aircraft including a fuselage, wings and stabilizers for pitch and yaw control, and a gas turbine engine including an air inlet, compressor section, combustion chamber turbine section and exhaust nozzle, wherein the improvement comprises:
the gas turbine engine mounted above the fuselage, the exhaust nozzle being positioned so that engine exhaust passes unimpeded above the fuselage and rearwardly of the aircraft; and
a controller adapted to process signals representing at least one of power settings for the gas turbine engine and feedback representing pitching moments responsive to changes in said power settings and consequent variations in engine thrust, and to output control signals to re-trim the aircraft.

15. The aircraft recited in claim 14, wherein the engine is disposed relative to a V-tail comprising a pair of stabilizers, such that engine exhaust expelled from the exhaust nozzle passes between the stabilizers of the V-tail during operation of the engine.

16. The aircraft recited in claim 14, wherein each of the stabilizers includes a leading edge, and the air inlet of the engine is disposed forwardly of the leading edges of the stabilizers.

17. The aircraft recited in claim 16, wherein the engine is mounted substantially along a longitudinal axis passing through the aircraft and a horizontal stabilizer, the engine being disposed above the fuselage.

18. The aircraft recited in claim 14, further including a trim system comprising a thrust vectoring assembly for changing a flow path of engine exhaust relative to a longitudinal axis of the aircraft, wherein the thrust vectoring assembly is responsive to the controller.

19. The aircraft recited in claim 14, further comprising a trim system for mechanically controlling pitch and yaw of the aircraft.

20. The aircraft recited in claim 19, wherein the trim system comprises at least one of adjustable stabilizers, spring cartridges, and trim tabs.

21. The aircraft recited in claim 14, wherein the controller includes a memory medium containing machine readable instructions which, when executed by a processor, enable the controller to generate control signals to proportionally adjust a movement of the trim system to maintain the aircraft in a trimmed state.

22. The aircraft recited in claim 21, wherein the controller is adapted to proportionally adjust a thrust vectoring assembly.

23. The aircraft recited in claim 22, wherein the controller is adapted to proportionally adjust a mechanical trim system.

24. A method of maintaining an aircraft having an engine mounted above a fuselage of the aircraft in a trimmed state, comprising the steps of:
processing signals representing power settings;
responsive to said power settings, calculating a thrust vectoring offset relative to a longitudinal axis extending through the aircraft so as to neutralize pitching moments caused by power setting changes and consequent variations in engine thrust; and
directing engine thrust along a path relative to the longitudinal axis in accordance with the calculated thrust vectoring offset.

25. A method of maintaining an aircraft having an engine mounted above a fuselage of the aircraft in a trimmed state, comprising the steps of:
sensing pitching moments acting on the aircraft;
responsive to said pitching moments, re-trimming the aircraft by vectoring engine thrust relative to a longitudinal axis of the aircraft.
